(19) United States
(12) Patent Application Publication
(10) Pub. No.: US 2026/0044260 A1
(43) Pub. Date: Feb. 12, 2026

(54) SOLID-STATE DRIVE AND DATA ACCESS ACCELERATION METHOD THEREOF

(71) Applicant: INNOGRIT TECHNOLOGIES CO.,LTD, Shanghai (CN)

(72) Inventors: Xiaoli RUI, San Jose, CA (US); Zining WU, San Jose, CA (US)

(21) Appl. No.: 19/295,274

(22) Filed: Aug. 8, 2025

Related U.S. Application Data
(60) Provisional application No. 63/682,147, filed on Aug. 12, 2024.

(51) Int. Cl. G06F 3/06

(52) U.S. Cl. CPC G06F 3/0611; G06F 3/0631; G06F 3/0659; G06F 3/0679

(57) ABSTRACT

The present application relates to information storage technology and discloses a solid-state drive and a data access acceleration method thereof. The method comprises: establishing, in the solid-state drive, a mapping relationship between an application identifier and a storage subspace in the solid-state drive, wherein the application identifier is used to uniquely identify an application or a group of applications in a host; the solid-state drive receiving a write command from the host, the write command comprising the application identifier and data to be written; the solid-state drive determining a target storage subspace to be written to according to the mapping relationship and the application identifier in the write command; and the solid-state drive writing the data to be written into the target storage subspace. The method can significantly improve the write and read performance of the solid-state drive.

### CROSS-REFERENCE TO RELATED APPLICATION

This U.S. Patent application claims the benefit of and priority to U.S. Provisional Application No. 63/682,147, filed Aug. 12, 2024, the content of which is incorporated herein by reference in its entirety for all purposes.

### TECHNICAL FIELD

The present application relates to the field of storage technology, and more particularly, to a data access acceleration technology for solid-state drives.

### BACKGROUND

This section is intended to provide background or context for understanding the embodiments of the present application, and is provided for reference only. It should not be construed as an admission by the applicant that this section constitutes prior art publicly disclosed before the filing date of this application.

With the rapid development of computer technology, solid-state drives (SSDs), as storage devices based on flash memory, have been widely used in fields such as personal computers and servers. SSDs mainly use NAND Flash Memory as the storage medium. Compared with traditional hard disk drives, SSDs have higher read/write speeds, lower power consumption, and better shock resistance performance, which can significantly improve data access efficiency.

In the data access process of an SSD, the Non-Volatile Memory Express (NVMe) protocol is widely used for communication between the host and the SSD. This protocol supports multi-queue parallel processing and can fully utilize the bandwidth of the PCIe interface to achieve efficient data transmission. However, the performance of an SSD varies significantly under different access modes. In a sequential access mode, data is read and written in a continuous manner, which can fully leverage the characteristics of NAND flash and provide high throughput. In contrast, a random access mode involves non-contiguous address operations, causing the NAND flash to frequently perform block erase and garbage collection operations, thereby increasing the write amplification effect and reducing overall performance.

In the prior art, data access optimization for SSDs mainly relies on caching mechanisms, prefetch strategies, or internal scheduling algorithms to alleviate the problems caused by random access. For example, some SSD controllers temporarily buffer random write data in DRAM and then convert it into sequential writes in batches to reduce the overhead of garbage collection. Although these methods improve performance to some extent, random access, especially mixed Input/Output (I/O) requests from multiple applications, still leads to high latency and unstable response times.

However, in the prior art, when an SSD processes random I/O requests, its inability to effectively distinguish between data streams from different sources can easily lead to storage space fragmentation, further exacerbating performance bottlenecks and latency issues.

### SUMMARY

An object of the present application is to provide a solid-state drive and a data access acceleration method thereof that can significantly improve the write and read performance of the solid-state drive.

An embodiment of the present application discloses a data access acceleration method for a solid-state drive, comprising: establishing, in the solid-state drive, a mapping relationship between an application identifier and a storage subspace in the solid-state drive, wherein the application identifier is used to uniquely identify an application or a group of applications in a host; the solid-state drive receiving a write command from the host, the write command comprising the application identifier and data to be written; the solid-state drive determining a target storage subspace to be written to according to the mapping relationship and the application identifier in the write command; and the solid-state drive writing the data to be written into the target storage subspace, wherein a starting physical address of the current write is contiguous with an ending physical address of the last written data in the target storage subspace. This method can achieve application-level physically contiguous address storage, thereby significantly improving the write and read performance of the solid-state drive. Specifically, this contiguous storage reduces addressing overhead caused by fragmentation, lowers latency, and increases data throughput. Especially in high-load application scenarios, it can effectively avoid the performance bottlenecks brought by traditional random storage, while also optimizing the flash memory management of the solid-state drive, extending hardware lifespan, and providing a foundation for subsequent batch reading, ultimately achieving overall data access acceleration.

Further, by receiving a read command containing an application identifier, determining a target storage subspace according to the mapping relationship, and reading all data according to the application identifier to return to the host, the read process can be simplified, achieving efficient batch data retrieval, thereby reducing the number of interactions between the host and the solid-state drive and improving system response speed. When this reading method is applied to AI training, the entire data in the target storage subspace can be read at once with a single read command according to the application identifier, avoiding the overhead of multiple read commands and greatly improving read efficiency.

Further, by dividing the application identifier into a first part and a second part, and dividing the storage subspace of the solid-state drive into first-level and second-level, a target first-level storage subspace is determined according to the first part, and then a target second-level storage subspace is further determined according to the second part. This can achieve hierarchical and fine-grained storage management, thereby improving the efficiency of storage resource allocation and the isolation between applications.

Further, by pre-allocating an initial storage subspace of a preset size for each application identifier, and checking the remaining capacity during writing, if it is insufficient, the capacity is dynamically expanded until it is sufficient before writing the data. This can flexibly accommodate the data growth needs of different applications, thereby avoiding write failures or fragmentation, and improving storage utilization and system reliability.

Further, by periodically detecting the physical address continuity of the storage subspaces and rescheduling and migrating data in non-contiguous parts, the continuity of the storage subspaces can be maintained, thereby continuously optimizing data access performance and reducing the potential impact of fragmentation.

Further, by determining a target first-level storage subspace according to the first part of the application identifier, identifying the access mode of the data to be written (e.g., sequential or random), and further determining a target second-level storage subspace based on this, optimized storage for different access modes can be achieved, thereby enhancing high throughput for sequential data and low-latency processing for random data.

Further, by defining data in the sequential access mode as including video streams, logs, or large file data, and data in the random access mode as including indexes, metadata, or structured record data, a more precise classification of access modes can be achieved. This provides targeted guidance for subsequent storage and read strategies, improving the efficiency of overall data processing.

Further, by adopting a corresponding prefetching strategy (such as large-block prefetch for sequential mode, small-block or no prefetch for random mode) according to the access mode when reading data from the target storage subspace, cache utilization and proactive loading can be optimized, thereby significantly reducing read latency and improving user experience.

Further, by optimizing a manner of writing the data to be written to achieve a higher speed before accelerating the writing of the data to the target storage subspace, the write performance can be further enhanced, thereby reducing overall I/O wait time and improving the responsiveness of the solid-state drive.

Further, by using the NVMe protocol to interact with the host and designing the write command as an extended write command that complies with the NVMe protocol, a standardized and efficient communication interface can be achieved, thereby ensuring compatibility with the existing hardware ecosystem and improving the reliability and speed of data transmission.

### BRIEF DESCRIPTION OF THE DRAWINGS

FIG. 1 is a schematic flowchart of a data access acceleration method for a solid-state drive according to an embodiment of the present application.

### DETAILED DESCRIPTION

In the following description, numerous technical details are set forth in order to provide a thorough understanding of the present application. However, those skilled in the art can understand that the technical solution claimed in this application can be realized without these technical details and various changes and modifications based on the following embodiments.

In order to make the objectives, technical solutions, and advantages of the present application clearer, embodiments of the present application will be further described in detail below with reference to the drawings.

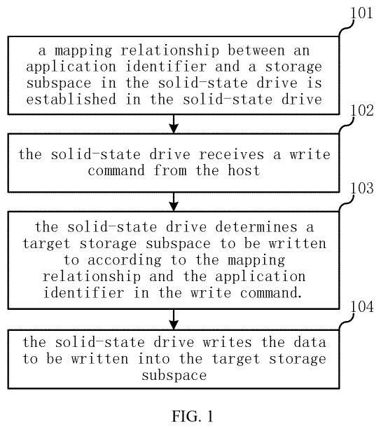

The first embodiment of the present application relates to a data access acceleration method for a solid-state drive, the flow of which is shown in FIG. 1. The method comprises the following steps:

In step 101, a mapping relationship between an application identifier and a storage subspace in the solid-state drive is established in the solid-state drive. The application identifier is used to uniquely identify an application or a group of applications in the host. The application identifier can be a number or string generated by the host and unique within that host. Preferably, in some embodiments, at least one storage subspace is internally physically contiguous. A storage subspace may comprise multiple storage units (such as flash pages or blocks). “A storage subspace is internally physically contiguous” means that the physical addresses of the multiple storage units within the storage subspace are continuous and sequentially adjacent in the NAND flash medium, with no address gaps or fragmentation. In some embodiments, a storage subspace may comprise multiple storage regions, each of which comprises multiple storage units with contiguous physical addresses.

In step 102, the solid-state drive receives a write command from the host, the write command comprising an application identifier and data to be written.

Thereafter, proceeding to step 103, the solid-state drive determines a target storage subspace to be written to according to the mapping relationship and the application identifier in the write command.

Thereafter, proceeding to step 104, the solid-state drive writes the data to be written into the target storage subspace, wherein a starting physical address of the current write is contiguous with an ending physical address of the last written data in the target storage subspace. If there is no data in the target storage subspace, writing starts from the starting physical address of the target storage subspace.

The aforementioned step 101 is a pre-configuration step, and steps 102-104 are processing steps performed after a write command is received.

The above method can be applied to all storage subspaces or only to some storage subspaces. It can be applied to all write commands or to some write commands (e.g., write commands with a specific application identifier, or write commands that satisfy other conditions).

The solid-state drive allocates an independent storage subspace for each application and stores data with the same application identifier from different write commands into the same storage subspace, such that data corresponding to the same application identifier is stored at physically contiguous addresses on the solid-state drive. For the same solid-state drive, even if write commands with different application identifiers are written in an interleaved manner, it is still possible to achieve physically contiguous storage of data corresponding to the same application identifier on the solid-state drive.

Optionally, in one embodiment, physically contiguous refers to continuous physical addresses managed by the flash translation layer (FTL) of the solid-state drive. A mapping table between application identifiers and flash physical block groups of the solid-state drive can be established in the FTL of the solid-state drive, with each flash physical block group constituting a storage subspace. Each physical block group contains pre-allocated contiguous physical blocks. The controller of the solid-state drive receives a write command from the host, the write command comprising an application identifier and data to be written; the FTL module of the controller determines the corresponding physical block group and the current write pointer within that physical block group according to the mapping table and the application identifier; the controller writes the data to be written to the physical page pointed to by the current write pointer, and updates the write pointer to point to the next contiguous physical page. By maintaining a dedicated write pointer for each application identifier and writing sequentially within pre-allocated contiguous physical blocks, physically contiguous storage of data corresponding to the same application identifier is achieved on the solid-state drive. Subsequently, the entire storage subspace can be read at once according to the application identifier. In this way, multiple pieces of data written dispersedly by different write commands with the same application identifier can be read at once, and since this data is physically contiguous, a sequential read method can be used to greatly speed up the read-out process.

Optionally, in one embodiment, the mapping relationship can be implemented with a static lookup table. This implementation is straightforward. The firmware maintains a table internally, where each row constitutes a mapping entry. The table uses the application identifier as the key and a structure describing the storage subspace as the value. This structure contains at least the following information: a physical starting address, which is the starting physical block address of the subspace in the NAND flash. A total capacity, which is the total amount of physical space reserved for the application identifier. A current write pointer, which points to the next available physical location for writing within the subspace. When a write command with a specific application identifier is received, the SSD controller can quickly locate the corresponding storage subspace and its current write position by querying this table, and write data contiguously at this position.

Optionally, in another embodiment, the mapping relationship may be implemented with a dynamic segment linked list. To utilize the flash space more flexibly, a storage subspace for an application can be composed of one or more physically contiguous “segments.” In this method, the mapping relationship links an application identifier to one or a group of segment descriptors. Each segment descriptor records the starting address and length of a contiguous physical block. When one segment is full, the firmware will find the next available contiguous free block as a new segment and add its information to the segment list for that application identifier. This method allows for the aggregation of multiple non-contiguous large blocks of space for the same application, while still maintaining physical data contiguity within each block.

By establishing a mapping relationship between application identifiers and physically contiguous storage subspaces within the solid-state drive (SSD), and writing data from the same application contiguously into a designated storage subspace based on the application identifier carried in the host's write command, it is possible to transform logical random IO access on the host side into sequential read/write operations on the SSD's physical storage. This transformation greatly leverages the physical characteristic of NAND flash media being much faster for sequential access than for random access, thereby significantly improving the IO access speed for specific applications and substantially reducing read/write latency. At the same time, because data is physically concentrated, the “Garbage Collection” operations required within the SSD due to data dispersion are reduced, lowering the Write Amplification factor. This not only further improves performance but also extends the lifespan of the SSD. This design, as a low-level optimization compatible with the standard NVMe protocol, can bring a transparent performance leap to upper-layer applications (especially those requiring high-performance IO, such as AI and big data).

Optionally, in one embodiment, during reading, the method further comprises the following steps: the solid-state drive receives a read command from the host, the read command including an application identifier; the solid-state drive determines a target storage subspace to be read according to the application identifier in the read command and the mapping relationship; the solid-state drive, according to the application identifier, reads all data in the determined target storage subspace and returns the read data to the host.

This reading method can accelerate data reading for AI image classification model training. In a typical AI application scenario: training an image classification deep learning model (e.g., ResNet) using a massive dataset (e.g., ImageNet) containing millions of small-sized image files.

In a standard AI training workflow, the DataLoader needs to read tens of thousands of batches of data from the hard drive in each training epoch. A batch usually contains dozens to hundreds of individual image files. Under the traditional method, this means initiating tens of thousands of separate file open and read operations. These operations bring huge I/O overhead, specifically including: file system overhead, where each read requires the host operating system (OS) to traverse the file system's directory tree, look up metadata, and perform logical-to-physical address translation. System call overhead, where a large number of read ( ) system calls cause frequent switches between user mode and kernel mode, consuming CPU resources. Random reads, where if these small files are physically stored in a scattered manner, the read operations become a large number of random I/Os, which is much slower than the sequential read speed of an SSD. These bottlenecks cause the data loading speed to fail to keep up with the GPU's computation speed, leaving expensive GPU resources in a waiting state for long periods, which severely affects overall training efficiency.

An example of the steps for dataset read/write in an AI training scenario is as follows:

### Step One: Dataset Writing and Establishment of the “AI Training Dataset Subspace”.

1. Defining an Application identifier: In the data preparation stage for training, the user or a data preparation tool defines a unique Application identifier for the entire ImageNet dataset, for example, the string “AI-TRAIN-IMGNET-V1”.
2. Data Writing: The user uses a specialized tool to write all one million-plus JPG image files in the dataset to the solid-state drive (SSD) of the present invention. For the write command of each file, the same application identifier “AI-TRAIN-IMGNET-V1” is attached.
3. SSD Internal Operation: The SSD's firmware recognizes that all these write commands carry the same application identifier. The SSD establishes a mapping relationship internally: “AI-TRAIN-IMGNET-V1”-\>Storage subspace A. The SSD writes all the received image data as a continuous data stream into a pre-allocated or dynamically expanded, physically contiguous “Storage subspace A”. After writing is complete, Storage subspace A is physically a huge and contiguous data block containing the entire ImageNet dataset. The SSD records the starting physical address and length of this subspace.

### Step Two: Efficient Data Reading in AI Model Training.

Initiate a Single Read command. After the AI model training begins, the data loader of the AI framework (such as PyTorch or TensorFlow) is configured to no longer read files one by one by filename. Instead, it issues a single, special read command to the host driver. The key parameter in this read command is the previously defined application identifier: “AI-TRAIN-IMGNET-V1”. The semantic of the command is to request a one-time return of all data in the storage subspace associated with this application identifier.

The SSD receives this read command carrying the “AI-TRAIN-IMGNET-V1” identifier. The SSD, based on its internal mapping relationship, quickly locates the physical starting address and length of Storage subspace A. The SSD's controller drives its flash array to perform a large-scale, uninterrupted Sequential Read operation, transferring the entire data in Storage subspace A (i.e., the entire dataset) at high speed in a streaming manner to the host's memory (RAM).

The host memory now contains a huge contiguous memory block with all the image data. The AI framework's data loader only needs to index and slice this data block in memory to quickly construct each required data batch, which is then sent to the GPU for training. Parsing data from memory is far faster than reading files from the hard drive.

Compared to traditional methods, this embodiment produces the following technical effects:

Exponential reduction in I/O overhead and latency. From millions of operations to a single operation: The millions of read ( ) system calls for millions of files are simplified into just a single, highly optimized read command. This almost completely eliminates the CPU overhead and time delay caused by file system lookups, metadata processing, and context switching. This method bypasses the slow file system layer in the host OS, achieving more direct communication between the application and the SSD's physical storage, thus avoiding the performance bottlenecks of the traditional I/O stack.

Achieving optimal SSD sequential read performance. Since the dataset is stored physically contiguously on the SSD, the single read operation is performed at the highest possible sequential read speed of the SSD hardware. This is in sharp contrast to the massive number of inefficient random reads caused by file fragmentation in traditional methods. The extremely high data read throughput ensures that the data supply speed can continuously match or even exceed the GPU's processing speed, keeping the expensive computing units in a fully loaded state, thereby greatly shortening the overall AI training time.

Simplifying the data management logic on the host side. The AI framework on the host side no longer needs to manage a complex list containing millions of file paths, nor does it need to handle tedious exceptions such as file not found or read errors. Its data loading logic is simplified to: request a data block, then process it in memory. This reduces the development and maintenance complexity of the upper-layer application.

Improving the atomicity of data access. The entire dataset is treated as a single unit for operations. This provides a solid foundation for future implementation of more advanced features such as dataset version control, snapshots, and consistent backups.

In summary, this embodiment, through the innovative model of “Application identifier-\>Target Subspace-\>One-time Full Read”, perfectly solves the small-file I/O storm problem in AI training scenarios, transforming data access from a bottleneck into a performance advantage, and providing powerful technical support for accelerating the research and development and iteration of AI models.

Optionally, in one embodiment, the SSD space can be managed in a hierarchical and grouped manner. Specifically, the application identifier includes a first part and a second part; the solid-state drive includes a plurality of first-level storage subspaces, and at least one first-level storage subspace includes a plurality of second-level storage subspaces. The solid-state drive determines a target first-level storage subspace according to the mapping relationship and the first part of the application identifier in the write command; the solid-state drive further determines a target second-level storage subspace in the target first-level storage subspace according to the second part of the application identifier in the write command. In one example, the first part can represent an application category, and the second part can represent an application sub-category. In one example, application identifiers ID1-ID4 each correspond to a first-level storage subspace; application identifiers ID5-ID7 collectively correspond to a first-level storage subspace; application identifier ID8 not only corresponds to a first-level storage subspace, but that first-level storage subspace further includes 2 second-level storage subspaces; application identifier ID9 not only corresponds to a first-level storage subspace, but that first-level storage subspace further includes 5 second-level storage subspaces; other application identifiers (i.e., those other than ID1-ID9) collectively correspond to a single first-level storage subspace.

Optionally, in one embodiment, the application identifier is a string, where the first several characters are the first part and the subsequent several characters are the second part. In another embodiment, the application identifier is a binary bit string, where the first several bits are the first part and the subsequent several bits are the second part.

Optionally, in one embodiment, the mapping relationship may adopt a hierarchical structure. For example, a 32-bit application identifier can be split into two parts: the high 16 bits are used as a first-level index, and the low 16 bits are used as a second-level index. The controller first uses the high 16 bits to find a pointer to a second-level mapping table in a first-level mapping table, and then uses the low 16 bits to find the final storage subspace descriptor in the corresponding second-level mapping table. This tree-like structure can efficiently manage a large number of application data classifications that have a hierarchical relationship.

Optionally, in one embodiment, step 101 may further comprise: pre-allocating a storage subspace of a preset size as an initial storage subspace for each application identifier. The preset size can be a predetermined value, a value configurable by the host, or a value determined according to the type of the application identifier. Step 104 further comprises: determining whether a remaining capacity of the target storage subspace is greater than or equal to the size of the data to be written; in response to the remaining capacity of the target storage subspace being greater than or equal to the size of the data to be written, writing the data to be written into the target storage subspace; in response to the remaining capacity of the target storage subspace being less than the size of the data to be written, dynamically expanding the capacity of the target storage subspace until its remaining capacity is greater than or equal to the size of the data to be written, and then writing the data to be written into the expanded target storage subspace. Dynamic expansion can be implemented by means such as, for example, allocating new blocks or migrating data. In one example, dynamically expanding the capacity of the target storage subspace comprises allocating additional blocks with contiguous physical addresses from a free storage area of the solid-state drive until the remaining capacity of the target storage subspace is greater than or equal to the size of the data to be written.

Optionally, in one embodiment, the data access acceleration method for a solid-state drive further comprises: the solid-state drive periodically detecting the physical address continuity of each storage subspace; for a storage subspace with discontinuous physical addresses, the solid-state drive rescheduling and migrating data therein to improve the physical address continuity of storage units within the storage subspace. In one example, the solid-state drive detects the physical address continuity of each storage subspace at a preset time interval (e.g., every 24 hours). If the fragmentation ratio exceeds a preset threshold (e.g., 10%), the solid-state drive reschedules and migrates the data in the physically discontiguous storage subspace to contiguous physical address blocks through a garbage collection mechanism. In another example, an engineer can manually initiate the physical address continuity detection of each storage subspace and the corresponding data scheduling when the system is idle.

Optionally, in one embodiment, the solid-state drive includes a plurality of first-level storage subspaces, and at least one first-level storage subspace includes a plurality of second-level storage subspaces. The solid-state drive determines a target first-level storage subspace according to the mapping relationship and a first part of the application identifier in the write command. The solid-state drive identifies an access mode of the data to be written, the access mode comprising a sequential access mode and a random access mode. The solid-state drive further determines a target second-level storage subspace in the target first-level storage subspace according to the access mode of the data to be written. The access mode of the data to be written can be the second part of the application identifier, a parameter in the write command (independent of the application identifier), or a predetermined flag. In one example, random writes (such as metadata) can be placed in an SLC cache or low-latency media, and sequential writes (such as video streams) can be placed in QLC or other high-density media.

The access mode of the data can be identified in various ways. For example, the host can identify the access mode by analyzing the write order and size of the data to be written; for instance, if the data block size exceeds a preset threshold and is written continuously, it is a sequential access mode, otherwise it is a random access mode. The host then informs the solid-state drive of the access mode by setting a specific flag in the write command. As another example, the solid-state drive can identify the access mode of the data to be written by analyzing the continuity of the logical block addresses (LBAs) of the write requests.

The data in the sequential access mode can include video stream data, log data, or large file data, etc., and the data in the random access mode can include index data, metadata, or structured record data, etc.

Optionally, in one embodiment, when the solid-state drive reads data in the target storage subspace, it adopts a corresponding prefetching strategy according to the access mode of the data, wherein the corresponding prefetching strategy comprises: adopting a large-block prefetch for data in the sequential access mode, and adopting a small-block prefetch or no prefetch for data in the random access mode. Large-block prefetch and small-block prefetch are relative concepts. For example, a first prefetch size can be used for large-block prefetch, and a second prefetch size smaller than the first prefetch size can be used for small-block prefetch. In one example, a large-block prefetch is a prefetch of a size of at least one flash Erase Block, and a small-block prefetch is a prefetch of a size equal to one flash Page.

Optionally, in one embodiment, before step 104, the method further comprises: optimizing a manner of writing the data to be written to enable the data to be written into the target storage subspace at a higher speed. The optimization of the writing manner can be varied:

In one example, multiple pieces of data to be written that have the same application identifier are aggregated in a high-speed cache area to form an aggregated data block; when a preset condition is met, the aggregated data block is written to the target storage subspace as a single write operation. For example, the solid-state drive controller aggregates multiple small write requests belonging to the same application identifier and destined for the same target storage subspace into one or more large, continuous data blocks in an internal high-speed cache (DRAM or SLC Cache). When the cache is full, or a certain time threshold is reached, or a specific flush command is received, this large data block is then written at once and sequentially to the target subspace in the main flash medium (e.g., TLC/QLC). By converting a large number of inefficient small random writes into efficient large sequential block writes, the write performance is greatly improved, and write amplification is reduced.

In another example, before executing a write, the SSD controller performs alignment or padding on the “data to be written” based on the characteristics of the physical flash where the target storage subspace is located (e.g., page size is 16 KB). This ensures that each write operation is page-aligned, avoiding cross-page writes or the generation of invalid data, thereby eliminating expensive “Read-Modify-Write” operations. This can reduce unnecessary internal data movement, lower write latency, and improve flash lifespan.

In another example, the data to be written is decomposed into multiple data segments; and, utilizing the multiple parallel flash channels of the solid-state drive, the multiple data segments are written in parallel to different physical locations of the target storage subspace. For example, when the solid-state drive receives a larger write command, the controller can identify that this is a large data block belonging to a specific “application identifier”. The controller of the solid-state drive can decompose this large data block into multiple small segments, and then write these data segments simultaneously to different physical flash chips allocated to that target storage subspace through its internal multiple parallel channels. This can multiply the write bandwidth, fully utilizing the hardware parallelism of the SSD.

Optionally, in one embodiment, the solid-state drive interacts with the host using the NVMe protocol, and the write command is an extended write command that complies with the NVMe protocol. For example, the write command is an extended write command that complies with the NVMe protocol, wherein an application identifier field is added to a custom part (e.g., the vendor-specific portion) of the NVMe command structure.

A second embodiment of the present application relates to a solid-state drive, comprising: a memory, configured to store computer-executable instructions; and a processor, coupled to the memory and configured to, upon executing the computer-executable instructions, perform the steps in the data access acceleration method for a solid-state drive of the first embodiment.

Accordingly, an embodiment of the present application also provides a computer-readable storage medium, on which computer-executable instructions are stored, which, when executed by a processor, implement the various method embodiments of the present application. The computer-readable storage media include permanent and non-permanent, removable and non-removable media that implemented by any method or technology for storage of information. Information can be computer-readable instructions, data structures, program modules, or other data. Examples of the computer-readable storage media include, but are not limited to, Phase-Change Random Access Memory (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory or other memory technologies, Compact Disc Read-Only Memory (CD-ROM), Digital Versatile Disc (DVD) or other optical storage, magnetic cassettes, magnetic disk storage or other magnetic storage devices, or any other non-transitory medium that can be used to store information accessible by a computing device. As defined herein, computer-readable storage media do not include transitory computer-readable media, such as modulated data signals and carriers.

Furthermore, an embodiment of the present application also provides a computer program product, which includes computer-executable instructions that, when executed by a processor, perform the steps in the various method embodiments described above.

It should be noted that, in this application, relational terms such as “first”, “second”, etc. are used solely to distinguish one entity or operation from another without necessarily requiring or implying any actual relationship or order between the entities or operations. Moreover, the term “comprise”, “include”, or any other variants thereof are intended to cover a non-exclusive inclusion, such that a process, method, article, or apparatus that comprises a list of elements not only comprises those elements, but may also comprise other elements not expressly listed or inherent to such a process, method, article, or apparatus. In the absence of more constraints, an element preceded by “comprises a . . . ” does not preclude the existence of additional identical elements in the process, method, article, or apparatus that comprises the element. In this application, if it is mentioned that an action is performed based on a certain element, it means performing that action based on at least that element, which includes two situations: (1) the behavior is performed only according to that element, and (2) the behavior is performed according to that element and other elements. The expressions ‘multiple’ and ‘a plurality of’ are defined to mean two or more than two.

The sequence numbers used in describing the steps of the method do not, in themselves, constitute any limitation on the order of those steps. For example, a step with a larger sequence number does not necessarily have to be executed after a step with a smaller sequence number; the step with the larger number could be executed before the step with the smaller number, or they could be executed in parallel, as long as such an execution order is reasonable to a person skilled in the art. For example, multiple steps with consecutive sequence numbers (e.g., step 101, step 102, step 103, etc.) do not restrict other steps from being performed in between them; for instance, there can be other steps between step 101 and step 102.

The specification includes combinations of the various embodiments described herein. Separate references to embodiments (e.g., “an embodiment” or “some embodiments” or “preferred embodiments”) do not necessarily refer to the same embodiment; however, these embodiments are not mutually exclusive unless indicated as such or as will be apparent to those skilled in the art. It should be noted that the word “or” is used in this specification in a non-exclusive sense unless the context expressly indicates or requires otherwise.

All documents mentioned in this specification are deemed as included in the disclosure of this application in their entirety so that they may serve as a basis for amendment if necessary. Furthermore, it should be understood that the above are only preferred embodiments of this specification and are not intended to limit the scope of protection of this specification. Any modification, equivalent replacement, improvement, etc. within the spirit and principles of one or more embodiments of this specification shall be included in the scope of protection of such one or more embodiments of this specification.

In some cases, the actions or steps described in the claims may be executed in an order different from that shown in the embodiments and still achieve the desired results. Additionally, the processes depicted in the drawings do not necessarily require the specific order or sequential order shown to achieve the desired results. In certain embodiments, multi-tasking and parallel processing may also be possible or advantageous.

What is claimed is:

1. A data access acceleration method for a solid-state drive, comprising:
establishing, in the solid-state drive, a mapping relationship between an application identifier and a storage subspace in the solid-state drive, wherein the application identifier is used to uniquely identify an application or a group of applications in a host;
the solid-state drive receiving a write command from the host, the write command comprising the application identifier and data to be written;
the solid-state drive determining a target storage subspace to be written to according to the mapping relationship and the application identifier in the write command;
the solid-state drive writing the data to be written into the target storage subspace, wherein a starting physical address of the current write is contiguous with an ending physical address of the last written data in the target storage subspace.

2. The data access acceleration method for a solid-state drive of claim 1, wherein the method further comprises:
the solid-state drive receiving a read command from the host, the read command comprising an application identifier;
the solid-state drive determining a target storage subspace to be read according to the application identifier in the read command and the mapping relationship;
the solid-state drive reading, based on the application identifier, all data in the determined target storage subspace and returning the read data to the host.

3. The data access acceleration method for a solid-state drive of claim 1, wherein the application identifier comprises a first part and a second part; the solid-state drive comprises a plurality of first-level storage subspaces, and at least one of the first-level storage subspaces comprises a plurality of second-level storage subspaces;
the determining by the solid-state drive the target storage subspace to be written to according to the mapping relationship and the application identifier in the write command further comprises:
the solid-state drive determining a target first-level storage subspace according to the mapping relationship and the first part of the application identifier in the write command;
the solid-state drive further determining a target second-level storage subspace in the target first-level storage subspace according to the second part of the application identifier in the write command.

4. The data access acceleration method for a solid-state drive of claim 1, wherein the establishing, in the solid-state drive, the mapping relationship between the application identifier and the storage subspace in the solid-state drive further comprises:
pre-allocating a storage subspace of a preset size as an initial storage subspace for each application identifier;
the solid-state drive writing the data to be written into the target storage subspace, further comprises:
determining whether a remaining capacity of the target storage subspace is greater than or equal to the size of the data to be written;
in response to the remaining capacity of the target storage subspace being greater than or equal to the size of the data to be written, writing the data to be written into the target storage subspace;
in response to the remaining capacity of the target storage subspace being less than the size of the data to be written, dynamically expanding the capacity of the target storage subspace until its remaining capacity is greater than or equal to the size of the data to be written, and writing the data to be written into the expanded target storage subspace.

5. The data access acceleration method for a solid-state drive of claim 4, wherein the method further comprises:
the solid-state drive periodically detecting physical address continuity of each storage subspace;
for a storage subspace with discontinuous physical addresses, the solid-state drive rescheduling and migrating data therein to improve the physical address continuity of storage units within the storage subspace.

6. The data access acceleration method for a solid-state drive of claim 1, wherein the solid-state drive comprises a plurality of first-level storage subspaces, and at least one of the first-level storage subspaces comprises a plurality of second-level storage subspaces;
the determining by the solid-state drive the target storage subspace to be written to according to the mapping relationship and the application identifier in the write command further comprises:
the solid-state drive determining a target first-level storage subspace according to the mapping relationship and a first part of the application identifier in the write command;
the solid-state drive identifying an access mode of the data to be written, the access mode comprising a sequential access mode and a random access mode;
the solid-state drive further determining a target second-level storage subspace in the target first-level storage subspace according to the access mode of the data to be written.

7. The data access acceleration method for a solid-state drive of claim 6, wherein the data in the sequential access mode comprises video stream data, log data, or large file data, and the data in the random access mode comprises index data, metadata, or structured record data.

8. The data access acceleration method for a solid-state drive of claim 6, wherein when reading data in the target storage subspace, the solid-state drive adopts a corresponding prefetching strategy according to the access mode of the data, wherein the corresponding prefetching strategy comprises: adopting a large-block prefetch for data in the sequential access mode, and adopting a small-block prefetch or no prefetch for data in the random access mode.

9. The data access acceleration method for a solid-state drive of claim 1, wherein before the solid-state drive writes the data to be written into the target storage subspace, the method further comprises: optimizing a manner of writing the data to be written to enable the data to be written into the target storage subspace at a higher speed.

10. The data access acceleration method for a solid-state drive of claim 1, wherein the solid-state drive interacts with the host using the NVMe protocol, and the write command is an extended write command that complies with the NVMe protocol.

11. A solid-state drive, comprising:
a memory, configured to store computer-executable instructions; and
a processor, coupled to the memory and configured to, upon executing the computer-executable instructions, perform the method of claim 1.

12. A non-transitory computer-readable storage medium, storing computer-executable instructions that, when executed by a processor, cause the processor to perform the steps of the method of claim 1.
